(19) United States
(12) Patent Application Publication
(10) Pub. No.: US 2023/0370875 A1
(43) Pub. Date: Nov. 16, 2023

(54) PDCCH BLIND DECODING REDUCTION

(71) Applicant: QUALCOMM Incorporated, San Diego, CA (US)

(72) Inventors: Hua WANG, Basking Ridge, NJ (US); Sony AKKARAKARAN, Poway, CA (US); Tao LUO, San Diego, CA (US); Junyi LI, Fairless Hills, PA (US)

(21) Appl. No.: 17/663,416

(22) Filed: May 13, 2022

(51) Int. Cl. H04W 24/08; H04W 72/04; H04L 1/00

(52) U.S. Cl. CPC H04W 24/08; H04W 72/042; H04W 72/0453; H04L 1/0038

(57) ABSTRACT

A base station may transmit to a first UE, and the first UE may receive from the base station, a DCICI message associated with a first SS and a first monitoring occasion. The DCICI message may be indicative of information for locating at least one PDCCH associated with the first SS and the first monitoring occasion. The base station may transmit to the first UE at the first monitoring occasion at least one DCI message via the at least one PDCCH associated with the first SS and the first monitoring occasion. The first UE may decode, based on successful decoding of the DCICI message, the at least one DCI message based on the information for locating the at least one PDCCH associated with the first SS and the first monitoring.

### FIELD

The present disclosure relates generally to communication systems, and more particularly, to blind decoding of physical downlink control channel (PDCCH) candidates in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first network node (e.g., a user equipment (UE)). The apparatus may receive, from a second network node (e.g., a base station), a downlink control information (DCI) candidate indication (CI) (DCICI) message associated with a first search space (SS) and a first monitoring occasion. The DCICI message may be indicative of information for locating at least one physical downlink control channel (PDCCH) associated with the first SS and the first monitoring occasion. The first network node may decode, based on successful decoding of the DCICI message, a first DCI message based on the information for locating the at least one PDCCH associated with the first SS and the first monitoring occasion. The first DCI message may correspond to the at least one PDCCH associated with the first SS and the first monitoring occasion.

In an aspect of the disclosure, a method, a computer-readable medium, and an apparatus are provided. The apparatus may be a first network node (e.g., a base station). The first network node may transmit, to a second network node (e.g., a UE), a DCICI message associated with a first SS and a first monitoring occasion. The DCICI message may be indicative of information for locating at least one PDCCH associated with the first SS and the first monitoring occasion. The first network node may transmit, to the second network node at the first monitoring occasion, a first DCI message via the at least one PDCCH associated with the first SS and the first monitoring occasion.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating example blind decoding and channel estimation for PDCCH candidates in connection with various ALs.

FIG. 5 is a diagram illustrating an example DCICI message in an SS.

FIG. 6A is a diagram illustrating an example DCICI message associated with a subsequent PDCCH monitoring occasion.

FIG. 6B is a diagram illustrating an example DCICI message associated with cross component carrier (CC) scheduling.

FIG. 7 is a diagram of a communication flow of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

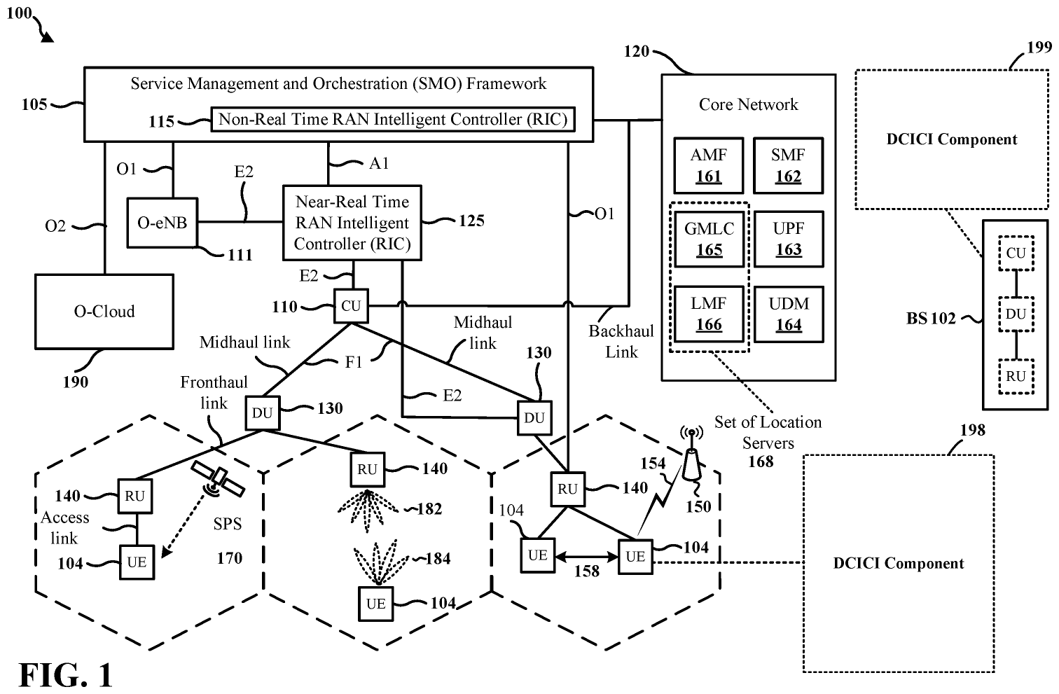

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a DCICI component 198 that may be configured to receive, from a base station, a DCICI message associated with a first SS and a first monitoring occasion. The DCICI message may be indicative of information for locating at least one PDCCH associated with the first SS and the first monitoring occasion. As described, herein, reference to the DCICI message being indicative of information may refer to the DCICI message itself being the information, the DCICI message including the information, or a combination thereof. The DCICI component 198 may be configured to decode at least one first DCI message based on the information for locating the at least one PDCCH associated with the first SS and the first monitoring occasion based on decoding of (e.g., successful decoding of) the DCICI message. The at least one first DCI message may be received via the at least one PDCCH associated with the first SS and the first monitoring occasion. In certain aspects, the base station 102 may include a DCICI component 199 that may be configured to transmit, to a first UE, a DCICI message associated with a first SS and a first monitoring occasion. The DCICI message may be indicative of information for locating at least one PDCCH associated with the first SS and the first monitoring occasion. The DCICI component 199 may be configured to transmit, to the first UE at the first monitoring occasion, at least one first DCI message via the at least one PDCCH associated with the first SS and the first monitoring occasion. Although the following description may be focused on 5G NR, the concepts described herein may be applicable to other similar areas, such as LTE, LTE-A, CDMA, GSM, and other wireless technologies.

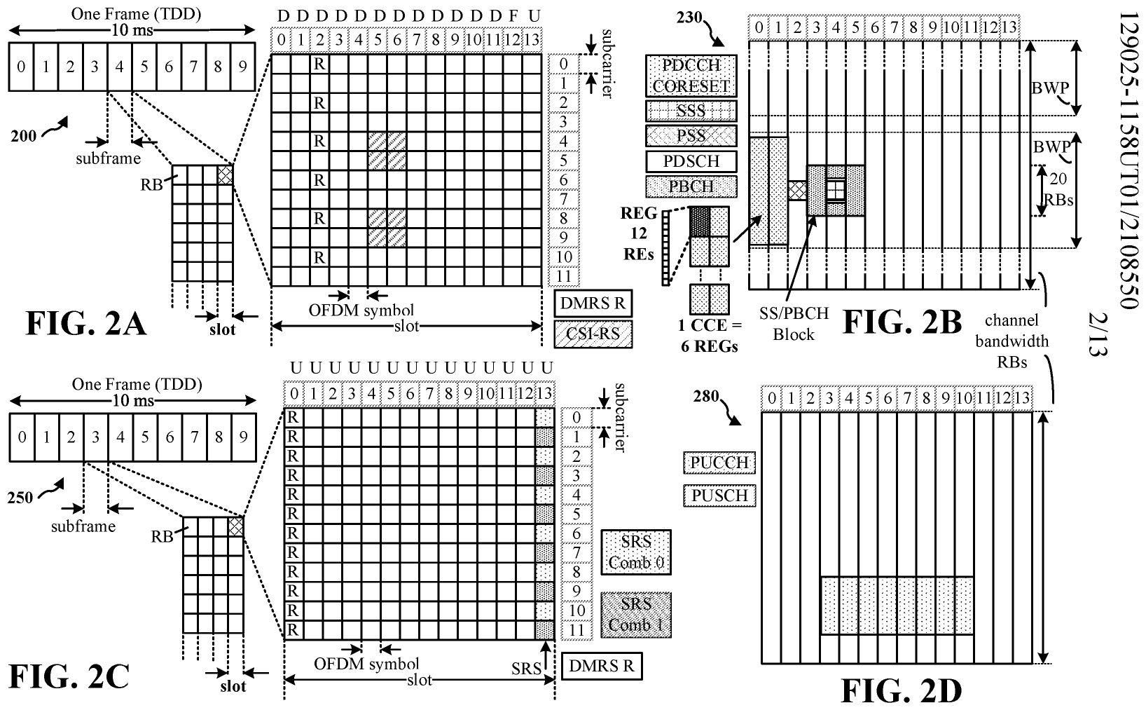

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2⁸²*15kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

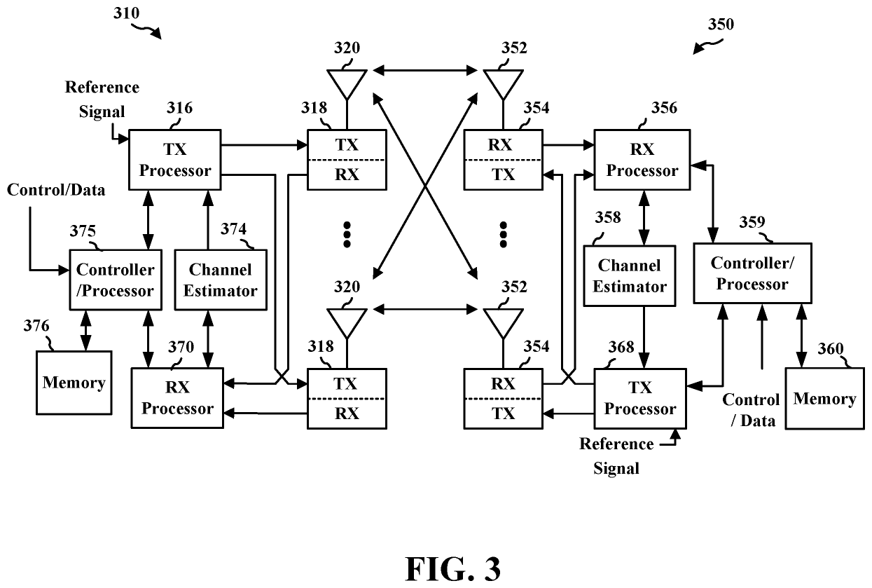

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The UL transmission is processed at the base station 310 in a manner similar to that described in connection with the receiver function at the UE 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

As described above, a PDCCH may carry a DCI message within one or more CCEs (e.g., 1, 2, 4, 8, or 16 CCEs), each CCE including a number of REGs (e.g., six REGs), each REG including a number of consecutive REs (e.g., 12 consecutive REs) in an OFDM symbol of an RB. An aggregation level (AL) may indicate the number of CCEs used to carry a DCI message. For example, for an AL of 2, 2 CCEs may be used together to carry a DCI message. A PDCCH within one BWP may be referred to as a CORESET. A UE may monitor PDCCH candidates in a PDCCH search space (SS) (also referred to as an SS set) (e.g., a common SS (set), a UE-specific SS (set)) during PDCCH monitoring occasions on the CORESET, where the PDCCH candidates may have different DCI formats and different ALs. The monitoring of the PDCCH candidates may be referred to as blind decoding. A base station may configure the PDCCH SS with RRC signaling. In different examples, options for the AL may include 1, 2, 4, 8, and 16. Further, in different examples, options for the number of PDCCH candidates in an SS for the selected AL may include 0, 1, 2, 3, 4, 5, 6, and 8. A UE may be configured with up to four BWPs and up to 10 SSs for each BWP in a serving cell. Accordingly, a UE may be configured with up to 40 SSs in total in a serving cell.

In one or more configurations, or an SS set s associated with CORESET p, the CCE indexes for AL L corresponding to PDCCH candidate m_{s,n}_{_{CI}} of the search space set in slot n_{s,f}^{μ} for an active DL BWP of a serving cell corresponding to carrier indicator field value n_{CI} may be given by a hash function

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{C C E , p} / L ⌋ \} + i$$

where for any common SS, Y_{p,n}_{^{μ}}_{_{s,f}}=0; for a UE-specific SS, Y_{p,n}_{^{μ}}_{s,f}=(Aₚ·Y_{p,n}_{^{μ}}_{_{s,f}}−1)modD, Y_{p,-1}=n_{RNTI}≈0, Aₚ=39827 for pmod3=0, Aₚ=39829 for pmod3=1, Aₚ=39839 for pmod3=2, and D=65537; i=0, . . . , L−1; N_{CCE,p} may be the number of CCEs, numbered from 0 to N_{CCE,p}=1, in CORESET p and, if any, per RB set; n_{CI} may be the carrier indicator field value if the UE is configured with a carrier indicator field by “CrossCarrierSchedulingConfig” for the serving cell on which PDCCH is monitored; otherwise, including for any common SS, n_{CI}=0; m_{s,n}_{_{CI}}=0, . . . , M_{s,n}_{_{CI}}^{(L)}−1, where M_{s,n}_{_{CI}}^{(L)} may be the number of PDCCH candidates the UE is configured to monitor for Al L of an SS set s for a serving cell corresponding to n_{CI}; for any common SS, M_{s,max}^{(L)}=M_{s,0}^{(L)}; for a UE-specific SS, M_{s,max}^{(L)} may be the maximum of M_{s,n}_{_{CI}}^{(L)} over all configured n_{CI} values for a CCE AL L of SS set s; the radio network temporary identifier (RNTI) value used for n_{RNTI} may be the cell RNTI (C-RNTI).

In one or more configurations, for each SS, there may be a relationship between the maximum number of PDCCH candidates for which blind decoding is performed, the maximum number of CCEs for which channel estimation is performed, and the SCS. An example relationship between the three variables may be summarized in the Table 1 below.

TABLE 1

| maximum # of | maximum | SCS |
|---|---|---|
| PDCCH candidates | # of CCEs | (kHz) |
| 44 | 56 | 15 |
| 36 | 56 | 30 |
| 22 | 48 | 60 |
| 20 | 32 | 120 |

Although there may be an upper bound on the number (e.g., quantity) of PDCCH candidates for which a UE may perform blind decoding in association with an SS, the base station may configure more blind decoding PDCCH candidates than a UE may be capable of processing. This may be referred to as overbooking.

In one or more configurations, the DCI message may comply with certain prespecified standards. For example, not including the bits used for the cyclic redundancy check (CRC), a DCI message may include at most 140 payload bits. A UE may monitor for up to three different DCI message sizes using the C-RNTI. Additionally, the UE may monitor for one additional DCI message size using RNTIs for special purposes. Accordingly, a UE may potentially monitor for up to four different DCI message payload sizes.

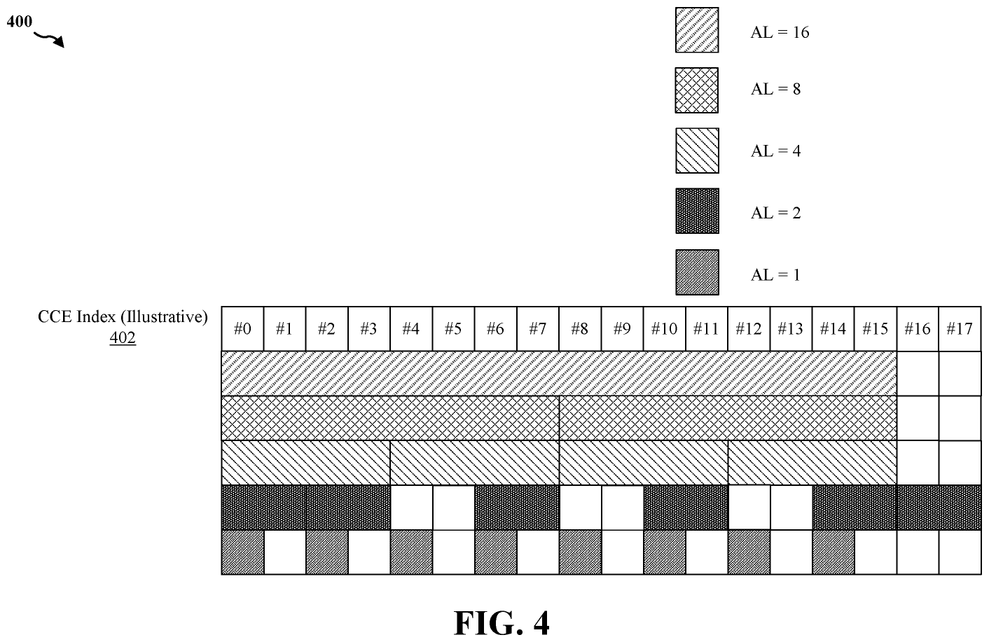

FIG. 4 is a diagram 400 illustrating example blind decoding and channel estimation for PDCCH candidates in connection with various ALs. In order to locate a DCI message, for an SS and at a PDCCH monitoring occasion, a UE may perform blind decoding and channel estimation for each PDCH candidate for all possible ALs. In the illustrated example, there may be 8 PDCCH candidates if the AL is 1, 6 PDCCH candidates if the AL is 2, 4 PDCCH candidates if the AL is 4, 2 PDCCH candidates if the AL is 8, and 1 PDCCH candidate if the AL is 16. Accordingly, if a UE performs blind decoding and traverses the ALs from the smallest AL (e.g., AL=1) to the largest AL (e.g., AL=16), and if the base station transmits a DCI message using an AL of 16, the UE may perform 21 (=8+6+4+2+1) PDCCH candidate blind decodes before the UE may locate the DCI message. The blind decodes and the associated channel estimation may increase power consumption, the effect of which may be particularly pronounced for power sensitive devices, such as reduced capability (RedCap) devices. Therefore, reducing the number (e.g., quantity) of blind decodes in the process of locating the DCI message may be desirable. It should be appreciated that while the number (e.g., quantity) of CCEs used for each AL is depicted in FIG. 4, the CCE indexes 402 used in the figure (#0 . . . 17) are illustrative. Because these illustrated CCE indexes 402 are not calculated based on the hash function described above, they do not correspond to the actual CCE indexes that may be used in a realistic scenario.

In one or more aspects, a base station may transmit, to a UE, a special DCI message to indicate, in relation to a PDCCH candidate that may actually carry a regular DCI message (i.e., an actual PDCCH), the time-frequency resource location of the PDCCH in an SS at a PDCCH monitoring occasion. The special DCI message may be referred to hereinafter as a DCI candidate indication (DCICI) message. Non-DCICI DCI messages may be referred to hereinafter simply as DCI messages. In particular, the DCICI message may indicate, for a PDCCH candidate that may actually carry a DCI message, one or more of an AL, a PDCCH candidate identifier (ID), or a CCE index. Further, the DCICI message may indicate a payload size of a DCI message.

In one or more configurations, the DCICI message may be associated with a special, dedicated RNTI that is not used for other DCI messages in order to differentiate the DCICI message from regular DCI messages. In particular, the CRC of the DCICI message may be scrambled using the special RNTI. The special RNTI may be a unicast RNTI, a groupcast RNTI, or a broadcast RNTI. The DCICI message may be transmitted via resources associated with a PDCCH candidate in the SS. In other words, the DCICI message may be transmitted via a DCICI PDCCH, which may be associated with an AL and a CCE index. Accordingly, the DCICI message may fit into an SS with minimal changes.

Accordingly, if a UE is able to decode a DCICI message addressed to the UE, the UE may decode DCI messages based on the resource location indication provided by the DCICI message. In other words, blind decoding of PDCCH candidates that may not carry a DCI message may be avoided. On the other hand, if a UE is unable to locate or decode a DCICI message, the UE may perform blind decoding for all possible PDCCH candidates as usual. In other words, the failure to decode the DCICI message by a UE may not affect the decoding of DCI messages by the UE.

In one configuration, while configuring the SS via RRC signaling, the base station may indicate, to a UE, a DCICI configuration. The DCICI configuration may indicate the subset of PDCCH candidates in the SS that may be used to carry the DCICI message. For example, for each PDCCH candidate that may carry a DCICI message (i.e., a DCICI PDCCH), the DCICI configuration may include an indication of a corresponding AL and a corresponding PDCCH candidate ID (or a CCE index). Accordingly, in one example, the DCICI configuration may include a sequence of (AL, PDCCH candidate ID) or (AL, CCE index) pairs. In one or more configurations, even if a PDCCH candidate is indicated in the DCICI configuration as being capable of carrying a DCICI message, the base station may still use the PDCCH candidate to carry a regular DCI message.

In one or more configurations, multiple UEs may use a same SS configuration. Accordingly, for UEs experiencing good channel conditions, a PDCCH candidate at a low AL may be used to carry the DCICI message. Further, for UEs experiencing poor channel conditions, a PDCCH candidate at a high AL may be used to carry the DCICI message, as a higher AL may improve the likelihood that a PDCCH candidate may be successfully decoded when the UE is experiencing a poor channel condition.

In one or more configurations, the base station may downselect, using a MAC—control element (CE) (MAC-CE) or a DCI message, for a UE, one or more PDCCH candidates that may carry DCICI messages from the subset of such PDCCH candidates that may have been configured via RRC signaling. In other words, from the RRC configured subset of PDCCH candidates that may carry DCICI messages, the base station may indicate, to the UE via a MAC-CE or a DCI message, one or more PDCCH candidates, for the UE, that may carry DCICI messages.

In one or more configurations, the base station may not configure the DCICI configuration while configuring the SS via RRC signaling. Rather, the base station may simply indicate, to a UE, the DCICI configuration via a MAC-CE or a DCI message.

As described above, multiple UEs may share a same SS. In one configuration, the base station may use the DCICI message to indicate, for a particular UE configured with the SS, the resource locations of one or more PDCCHs that may actually carry DCI messages for the particular UE. In another configuration, the base station may use the DCICI message to indicate, for a subset of UEs configured with the SS, the resource locations of one or more PDCCHs that may actually carry DCI messages for the subset of UEs. In yet another configuration, the base station may use the DCICI message to indicate, for all UEs configured with the SS, the resource locations of one or more PDCCHs that may actually carry DCI messages for any of the UEs. In one or more configurations, the base station may transmit more than one DCICI message for each PDCCH monitoring occasion. Therefore, for example, the base station may determine (e.g., identify) the UEs for which more power saving may be desired, and then may transmit one or more DCICI messages to specifically help those UEs reduce the number (e.g., quantity) of blind decodes.

In one example, a first UE and a second UE may be configured with a same SS. The base station may indicate in the DCICI configuration two PDCCH candidates that may carry the DCICI message (i.e., two DCICI PDCCH candidates). For instance, one of the two DCICI PDCCH candidates may be associated with an AL of 1 and a PDCCH candidate ID of 1, and the other of the two DCICI PDCCH candidates may be associated with an AL of 4 and a PDCCH candidate ID of 2. For the purpose of this example, it may be assumed that the two DCICI PDCCH candidates may not overlap in terms of constituent CCEs. It may be further assumed that, for example, due to different channel conditions, the first UE may be able to decode a DCICI message at an AL of 4, but may not be able to decode a DCICI message at an AL less than 4, and the second UE may be able to decode a DCICI message at an AL of 1. In this example, if the DCICI configuration received by the second UE via a MAC-CE or a DCI message indicates the DCICI PDCCH candidate associated with an AL of 1 and a PDCCH candidate ID of 1 but not the DCICI PDCCH candidate associated with an AL of 4 and a PDCCH candidate ID of 2 (e.g., a downselection via a MAC-CE or a DCI message as described above), the second UE may attempt to decode the DCICI PDCCH candidate associated with an AL of 1 and a PDCCH candidate ID of 1 but not the DCICI PDCCH candidate associated with an AL of 4 and a PDCCH candidate ID of 2. Otherwise (e.g., if there has not been a downselection), the second UE may attempt to decode both DCICI PDCCH candidates that may carry a DCICI message.

In one example, the base station may use the DCICI PDCCH candidate with the AL of 4 to transmit a DCICI message to the first UE. The DCICI message transmitted to the first UE may indicate the resource locations of PDCCH candidates that may carry DCI messages for the first UE, and may exclude any indication of resource locations of PDCCH candidates that may carry DCI messages for a different UE (e.g., the second UE). Further, the base station may use the DCICI PDCCH candidate with the AL of 1 to transmit a DCICI message to the second UE. The DCICI message transmitted to the second UE may indicate the resource locations of PDCCH candidates that may carry DCI messages for the second UE, and may exclude any indication of resource locations of PDCCH candidates that may carry DCI messages for a different UE (e.g., the first UE).

In another example, the base station may use the DCICI PDCCH candidate with the AL of 4 to transmit a DCICI message to both the first UE and the second UE. The DCICI message may indicate the resource locations of PDCCH candidates that may carry DCI messages for either the first UE or the second UE.

In yet another example, the base station may use the DCICI PDCCH candidate with the AL of 1 to transmit a DCICI message to both the first UE and the second UE. The DCICI message may indicate the resource locations of PDCCH candidates that may carry DCI messages for either the first UE or the second UE. However, it may be expected that the first UE may be unlikely to decode the DCICI message due to the channel condition experienced by the first UE.

In still another example, the base station may use the DCICI PDCCH candidate with the AL of 1 to transmit a DCICI message to the second UE. The DCICI message transmitted to the second UE may indicate the resource locations of PDCCH candidates that may carry DCI messages for the second UE, and may exclude any indication of resource locations of PDCCH candidates that may carry DCI messages for a different UE (e.g., the first UE). In this example, the base station may not transmit any DCICI message to the first UE.

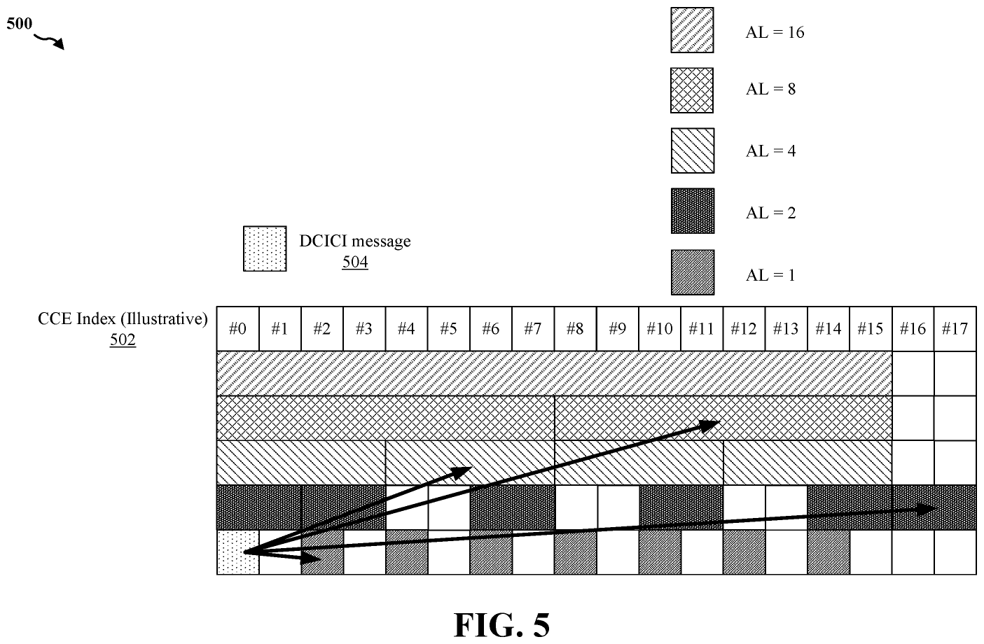

In still another example, the base station may not transmit a DCICI message at all. FIG. 5 is a diagram 500 illustrating an example DCICI message in an SS. In the figure, for each AL, the IDs of PDCCH candidates may be in ascending order from left to right, starting from 0. Accordingly, the DCICI message 504 may be carried via a PDCCH associated with an AL of 1 and a PDCCH candidate ID of 0. The DCICI message 504 may indicate the resource locations of 4 PDCCH candidates that may actually carry DCI messages, as shown by arrows in FIG. 5. As shown, the (AL, PDCCH candidate ID) pairs for the PDCCH candidates indicated by the DCICI message may include (AL=1, PDCCH candidate ID=1), (AL=2, PDCCH candidate ID=5), (AL=4, PDCCH candidate ID=1), (AL=8, PDCCH candidate ID=1).

In this illustrated example, if no DCICI message is provided, and if the UE starts the blind decoding with the AL of 1 and moves onto higher ALs, the UE may perform blind decoding for 15 (=8+5+3+1) PDCCH candidates in order to locate DCI message in all possible PDCCH candidates. It should be appreciated that after decoding the PDCCH with an AL of 1 and a PDCCH candidate ID of 1, the UE may skip one PDCCH candidate at each AL higher than 1, and may skip the AL of 16 altogether because a PDCCH candidate that overlaps with the decoded PDCCH with an AL of 1 and the PDCCH candidate ID of 1 in terms of constituent CCEs may not actually carry any DCI message. Herein two PDCCH candidates overlap each other in terms of constituent CCEs when the two PDCCH candidates include at least one same constituent CCE. Accordingly, PDCCH candidates at (AL=2, PDCCH candidate ID=1), (AL=4, PDCCH candidate ID=0), (AL=8, PDCCH candidate ID=0), and (AL=16, PDCCH candidate ID=0) may be skipped when the UE performs blind decoding. In contrast, with the assistance of two-stage DCI and the DCICI message, the UE may perform blind decoding for 5 PDCCH candidates (which may include the one PDCCH carrying the DCICI message and the 4 PDCCH candidates indicated in the DCICI message). In a further more extreme example described above, if the base station transmits a single DCI message via a PDCCH with an AL of 16 (and a PDCCH candidate ID of 0), with the assistance of the DCICI message, the number of blind decodes may be reduced from 21 to 2. It should be appreciated that similar to the CCE indexes 402 in FIG. 4, the CCE indexes 502 in FIG. 5 (#0 . . . 17) are illustrative as well. Because these illustrated CCE indexes 502 are not calculated based on the hash function described above, they do not correspond to the actual CCE indexes that may be used in a realistic scenario.

In one configuration, for each AL, the DCICI message may include a bitmap to indicate the PDCCH candidates that may actually carry DCI messages. Each bit in the bitmap may correspond to one PDCCH candidate, and the length of the bitmap may be equal to the number of configured PDCCH candidates for that AL. Accordingly, referring back to the example illustrated in FIG. 5, the ALs, the number of configured PDCCH candidates for each AL, the IDs of the PDCCH candidates that may actually carry DCI messages, and the bitmap for each AL in the DCICI message may be summarized in the Table 2 below.

TABLE 2

| | Number of | ID of PDCCH | Bitmap in |
|---|---|---|---|
| | PDCCH | candidate that | DCICI |
| AL | Candidates | may carry DCI | message |
| 1 | 8 | 1 | 11000000 |
| 2 | 6 | 5 | 000001 |
| 4 | 4 | 1 | 0100 |
| 8 | 2 | 1 | 01 |
| 16 | 1 | None | 0 |

If the DCICI message includes indications for multiple ALs, the DCICI message may include the multiple bitmaps for the multiple ALs that may be concatenated together. Any suitable order for arranging the bitmaps in the concatenation may be used. For example, bitmaps for lower ALs may be placed before bitmaps for higher ALs. If this configuration is used, the concatenated bitmaps for the example provided in Table 2 above may be “110000000000010100010.” For another example, bitmaps for higher ALs may be placed before bitmaps for lower ALs. Any other non-monotonous bitmap order may also be used. The bitmap order may be configurable or prespecified.

Further, different ordering of the bits in the bitmap may be used. In one example, the bits in the bitmap may be in ascending order of the PDCCH candidate ID (e.g., the bitmap may be b0b1 . . . b7, for 8 PDCCH candidates, where b0 may be the bit associated with the PDCCH candidate ID of 0, and so on). This may be the configuration used in the example provided in Table 2 above. In another example, the bits in the bitmap may be in descending order of the PDCCH candidate ID (e.g., the bitmap may be b7b6 . . . b0, also for 8 PDCCH candidates).

In different examples, the bit in the concatenated bitmaps that corresponds to the PDCCH candidate that carries the DCICI message may be set to either “0” or “1.” In the example provided in Table 2 above, the bit that corresponds to the PDCCH candidate that carries the DCICI message may be set to “1.”

In one configuration, the payload size of the DCICI message may be adjusted so that it may align with a possible payload size of a regular DCI message.

In one configuration, if more than one UE is configured with a same SS, the DCICI message may indicate the PDCCH candidates that may carry DCI messages for any of the UEs configured with the SS. In another configuration, the DCICI message may indicate the PDCCH candidates that may carry DCI messages for a subset of UEs configured with the SS, or a particular UE configured with the SS.

In one or more configurations, the AL of the PDCCH candidate used to carry the DCICI message may be selected based on the payload size (e.g., the number of bits) of the DCICI message. If the bitmaps described above are utilized, in a worst case scenario, if there are 8 configured PDCCH candidates for each AL, a total of 40 (=8×5 ALs) bits may be used for the bitmaps. An additional 24 bits may be used for the CRC, which may bring the total payload size to 64 bits. Accordingly, an AL of 2 may be used. On the other hand, in the example illustrated in FIG. 5, the bitmaps may take up 21 bits (corresponding to the 21 PDCCH candidates), and the total payload size may be 45 bits (including 21 bits for the bitmaps and 24 bits for the CRC). In this case, an AL of 1 may be sufficient. The AL of the PDCCH candidate used to carry the DCICI message may be selected and configured when the base station configures the SS as the number of configured PDCCH candidates for each AL may be known based on the SS configuration.

In one configuration, the DCICI message may not be used when the total number of PDCCH candidates associated with an SS is small (e.g., less than a threshold). For example, if the total number of PDCCH candidates associated with an SS is small, the base station may not indicate a DCICI configuration for the SS. In another example, if the total number of PDCCH candidates associated with an SS is small, the base station may not transmit a DCICI message for the SS.

The use of DCICI message may be associated with time-frequency resource costs. For example, if 4 PDCCH candidates are configured for an AL of 2, and one of the 4 PDCCH candidates is used to carry the DCICI message, there may be 3 PDCCH candidates at the AL of 2 left that may be used to carry DCI messages at the AL of 2.

Further, the use of the DCICI message may also reduce the number of PDCCH candidates usable for regular DCI messages at other ALs because constituent CCEs used for the DCICI message may not be available for use by PDCCH candidates at other ALs. For example, referring back to FIG. 5, because CCE #0 is used by the DCICI message, the PDCCH candidates at other ALs that also use CCE #0 (i.e., that overlap with the DCICI PDCCH in terms of constituent CCEs) may not be used to carry DCI messages. Such PDCCH candidates may include PDCCH candidates at (AL=2, PDCCH candidate ID=0), (AL=4, PDCCH candidate ID=0), (AL=8, PDCCH candidate ID=0), and (AL=16, PDCCH candidate ID=0). Therefore, in the worst case scenario, one PDCCH candidate may be lost for each AL when there is one PDCCH candidate at each AL that overlaps with the DCICI PDCCH in terms of constituent CCEs. Of course, it should be appreciated that even without the DCICI message, if any one of the PDCCH candidates that would be lost as a result of the use of the DCICI message is used to carry a DCI message, any other PDCCH candidate within those PDCCH candidates may not be used to carry any additional DCI messages either because all these PDCCH candidates overlap in terms of constituent CCEs.

In one or more configurations, if the base station finds that including a DCICI message limits excessively the flexibility associated with available PDCCH candidates, the base station may not transmit a DCICI message. In other words, the base station may transmit the DCICI message in an opportunistic fashion, that is, when the actual cost associated with the use of a DCICI message is negligible or at least tolerable. For example, in the example illustrated in FIG. 5, if both PDCCH candidates for an AL of 8 are to be used to carry DCI messages, the base station may not transmit a DCICI message, so as not to lose either of the PDCCH candidates for an AL of 8.

If the base station does not transmit a DCICI message, the UE may not be able to find a DCICI message at the DCICI PDCCH candidate as indicated by the DCICI configuration. In this case, the UE may perform blind decoding on all possible PDCCH candidates as usual in order to obtain all the DCI messages. Therefore, configuring but not using the DCICI message may not increase the amount of blind decoding at the UE. Because a PDCCH candidate may be configured to potentially carry the DCICI message but may actually carry a regular DCI message instead, the DCICI message may be associated with a special, dedicated RNTI that is not used for other DCI messages in order to differentiate the DCICI message from regular DCI messages. In particular, the CRC of the DCICI message may be scrambled using the special RNTI. The special RNTI may be a unicast RNTI, a groupcast RNTI, or a broadcast RNTI. For example, in the example of FIG. 5, the base station may use all 8 PDCCH candidates for an AL of 1 to carry DCI messages, and may not transmit the DCICI message via the PDCCH candidate at (AL=1, PDCCH candidate ID=0), which PDCCH candidate may be indicated in the DCICI configuration as potentially carrying a DCICI message. Because the special RNTI is not used for the regular DCI message carried via this PDCCH candidate, the UE may be able to determine that the DCI message carried via this PDCCH candidate is actually a regular DCI message and not a DCICI message.

Of course, because a special RNTI is used to scramble the CRC of the DCICI message, there may be additional processing cost at the UE associated with attempting to decode the PDCCH candidate indicated in the DCICI configuration based on the additional special RNTI.

In one configuration, the blind decoding counting at the UE may be based on the actual number of blind decodes performed by the UE. In one configuration, the base station may assume the UE may not be able to decode the DCICI message even if the base station transmits a DCICI message when the base station configures the SS and elects to use overbooking.

In one configuration, the payload size of the DCICI message may be prespecified, which may be different from all four possible payload sizes of regular DCI messages. In another configuration, the payload of the DCICI message may be adjusted (e.g., via chopping, puncturing, or padding) so that the payload size of the DCICI message may be aligned with the payload size of one of regular DCI formats. If a prespecified payload size that is different from the payload sizes of regular DCI messages is used for the DCICI message, the UE may decode the PDCCH candidate carrying the DCICI message based on the prespecified payload size of the DCICI message. In one configuration, the DCI size alignment rules for regular DCI messages may be used for the DCICI message.

In one or more configurations, when the UE fails to locate a DCICI message based on decoding a PDCCH candidate indicated in the DCICI configuration as potentially carrying a DCICI message, the UE may perform blind decoding on all PDCCH candidates in a certain order. In one example, the UE may fail to locate any DCI message based on decoding the PDCCH candidate indicated in the DCICI configuration as potentially carrying a DCICI message. In this case, it may be likely that the base station has not transmitted a DCICI message because the base station may wish to use a PDCCH candidate (with a different AL) whose constituent CCEs overlap with the constituent CCEs of the PDCCH candidate indicated in the DCICI configuration in order to transmit a regular DCI message. Therefore, the UE may first attempt to perform blind decoding on the PDCCH candidates whose constituent CCEs overlap with the constituent CCEs of the PDCCH candidate indicated in the DCICI configuration. In the example of FIG. 5, as mentioned above, such PDCCH candidates may include the PDCCH candidates at (AL=2, PDCCH candidate ID=0), (AL=4, PDCCH candidate ID=0), (AL=8, PDCCH candidate ID=0), and (AL=16, PDCCH candidate ID=0). Accordingly, the UE may be able to locate a DCI message based on decoding one of these PDCCH candidates.

In another example, the UE may locate a regular DCI message based on decoding the PDCCH candidate indicated in the DCICI configuration. In this case, it may be likely that the base station may wish to use all PDCCH candidates at the same AL as the PDCCH candidate indicated in the DCICI configuration in order to transmit regular DCI messages. Therefore, the UE may first attempt to perform blind decoding on the PDCCH candidates associated with the same AL as the PDCCH candidate indicated in the DCICI configuration. Accordingly, the UE may be able to locate DCI messages based on decoding these PDCCH candidates.

In one or more examples, for some UE implementations, the order of blind decoding of PDCCH candidates for a current slot may be pre-computed. In other words, the blind decoding timeline of such a UE may not be adjustable based on information carried in the same slot. Accordingly, such a UE may not be able to benefit from receiving a DCICI message and reducing the blind decoding complexity in the same slot based on the DCICI message. Accordingly, in one or more examples, the UE may transmit, to the base station, an indication of whether the UE is capable of adjusting the PDCCH candidate blind decoding timeline for a slot based on information obtained from the same slot. Therefore, based on the indication of the UE capability, if a UE is capable of adjusting the PDCCH candidate blind decoding timeline for a slot based on information obtained from the same slot, the base station may transmit a DCICI message for the current slot to the UE. On the other hand, if the UE is not capable of adjusting the PDCCH candidate blind decoding timeline for a slot based on information obtained from the same slot, the base station may transmit a DCICI message associated with a subsequent PDCCH monitoring occasion (i.e., not the current PDCCH monitoring occasion) to the UE. The base station may select the time gap between the DCICI message and the subsequent PDCCH monitoring occasion to which the DCICI message relates based on the capability of the UE.

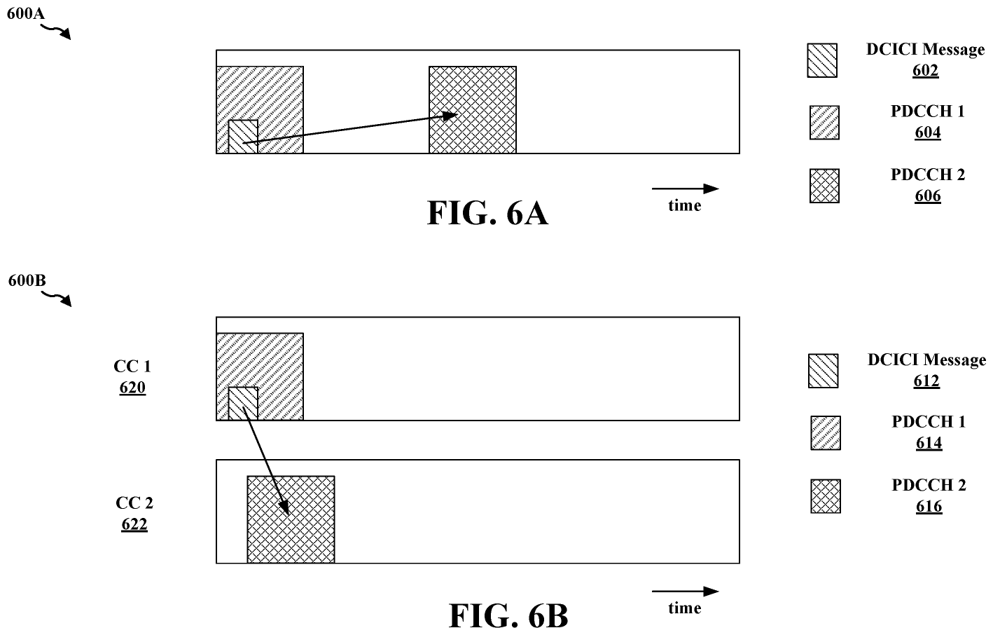

FIG. 6A is a diagram 600 A illustrating an example DCICI message associated with a subsequent PDCCH monitoring occasion. In FIG. 6A, the DCICI message 602 may be carried via a first PDCCH 604, and may indicate a resource location of a second PDCCH candidate 606 that may carry a DCI message. The second PDCCH 606 may be associated with a PDCCH monitoring occasion that is subsequent to the PDCCH monitoring occasion with which the first PDCCH 604 may be associated. In different examples, the first PDCCH 604 and the second PDCCH 606 may be associated with the same SS, or with different SSs. Accordingly, the base station may configure the SS and the PDCCH monitoring occasion to which the DCICI message is related (e.g., the SS and the PDCCH monitoring occasion the DCICI message points to). Therefore, the DCICI message may indicate the SS (e.g., using an SS index) and the PDCCH monitoring occasion to which the DCICI message is related (e.g., the SS and the PDCCH monitoring occasion the DCICI message points to). In one configuration, a PDCCH monitoring occasion may be indicated in the DCICI message using a slot or symbol offset relative to the slot or symbol in which the DCICI message is transmitted.

FIG. 6B is a diagram 600 B illustrating an example DCICI message associated with cross component carrier (CC) scheduling. In FIG. 6B, the DCICI message 612 may be carried via a first PDCCH 614, and may indicate a resource location of a second PDCCH 616 that may carry a DCI message. The first PDCCH 614 may be carried via a first CC 620. The second PDCCH 616 may be carried via a second CC 622. Therefore, the DCICI message 612 may indicate the second PDCCH 616 that may be carried via a different CC from the first PDCCH 614. Accordingly, the DCICI message 612 may indicate, using a CC indicator, the CC associated with the SS to which the DCICI message may relate. For example, the DCICI message 612 may include an indication of the second CC 622.

In one configuration, a DCICI message may indicate the payload size of the regular DCI message. As described above, a UE may monitor for up to four different possible DCI message payload sizes. In particular, a UE may monitor for up to three different DCI message sizes using the C-RNTI. Additionally, the UE may monitor for one additional DCI message size using RNTIs for special purposes. Accordingly, the payload size of a DCI message may be indicated using 2 bits (four possibilities may be encoded in 2 bits). In one example, in the concatenated bitmaps in the DCICI message, after each bit whose value has been set to “1” (indicating that the corresponding PDCCH candidate may be a PDCCH carrying a DCI message), 2 more bits may be inserted to indicate one of the four possible DCI message payload sizes.

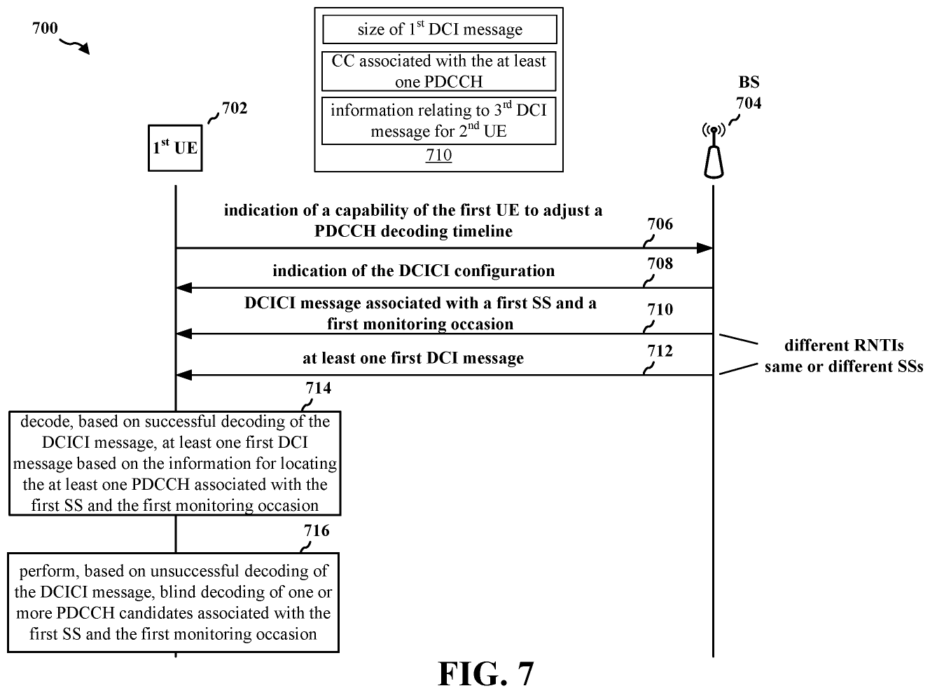

FIG. 7 is a diagram of a communication flow 700 of a method of wireless communication. At 706, the first UE 702 may transmit, to the base station 704, and the base station 704 may receive, from the first UE 702, an indication of a capability of the first UE 702 to adjust a PDCCH decoding timeline.

At 708, the base station 704 may transmit, to the first UE 702, and the first UE 702 may receive, from the base station 704, an indication of a DCICI configuration via at least one of RRC signaling, a second DCI message, or a MAC-CE. The DCICI configuration may include an AL associated with a DCICI PDCCH and at least one of a PDCCH candidate ID associated with the DCICI PDCCH or a CCE index associated with the DCICI PDCCH.

At 710, the base station 704 may transmit, to the first UE 702, and the first UE 702 may receive, from a base station 704, a DCICI message associated with a first SS and a first monitoring occasion. The DCICI message 710 may be indicative of information for locating at least one PDCCH associated with the first SS and the first monitoring occasion.

In one configuration, the DCICI message 710 may be associated with the DCICI configuration. The DCICI message 710 may be decoded based on the DCICI configuration.

In one configuration, the information for locating the at least one PDCCH associated with the first SS and the first monitoring occasion may include, for each PDCCH in the at least one PDCCH, an AL associated with the PDCCH and at least one of a PDCCH candidate ID associated with the PDCCH or a CCE index associated with the PDCCH.

In one configuration, the at least one PDCCH associated with the first SS and the first monitoring occasion and the DCICI PDCCH may be associated with different CCE indexes.

In one configuration, the first monitoring occasion may correspond to a first PDCCH monitoring occasion.

In one configuration, the DCICI message 710 may be transmitted by the base station 704 and received by the UE 702 via the first SS at the first monitoring occasion.

In one configuration, the DCICI message 710 may be transmitted by the base station 704 and received by the UE 702 via a second monitoring occasion prior to the first monitoring occasion, and may be received via the first SS or an SS different from the first SS.

In one configuration, the DCICI message 710 may further include an indication of a size of the at least one first DCI message.

In one configuration, the DCICI message 710 may further include an indication of a CC associated with the at least one PDCCH.

In one configuration, the DCICI message 710 may further include information relating to at least one third DCI message associated with the first SS and the first monitoring occasion. The at least one third DCI message may be for a second UE.

In one configuration, the DCICI message 710 may be associated with a special RNTI. The special RNTI may be different from an RNTI associated with the at least one first DCI message.

In one configuration, a number (e.g., quantity) of one or more PDCCH candidates associated with the first SS may be greater than a threshold.

At 712, the base station 704 may transmit, to the first UE 702 at the first monitoring occasion, at least one first DCI message via the at least one PDCCH associated with the first SS and the first monitoring occasion.

At 714, the first UE 702 may decode, based on decoding of (e.g., successful decoding of) the DCICI message 710, at least one first DCI message 712 based on the information for locating the at least one PDCCH associated with the first SS and the first monitoring occasion.

At 716, the first UE 702 may perform, based on decoding of (e.g., unsuccessful decoding of) the DCICI message 710, blind decoding of one or more PDCCH candidates associated with the first SS and the first monitoring occasion.

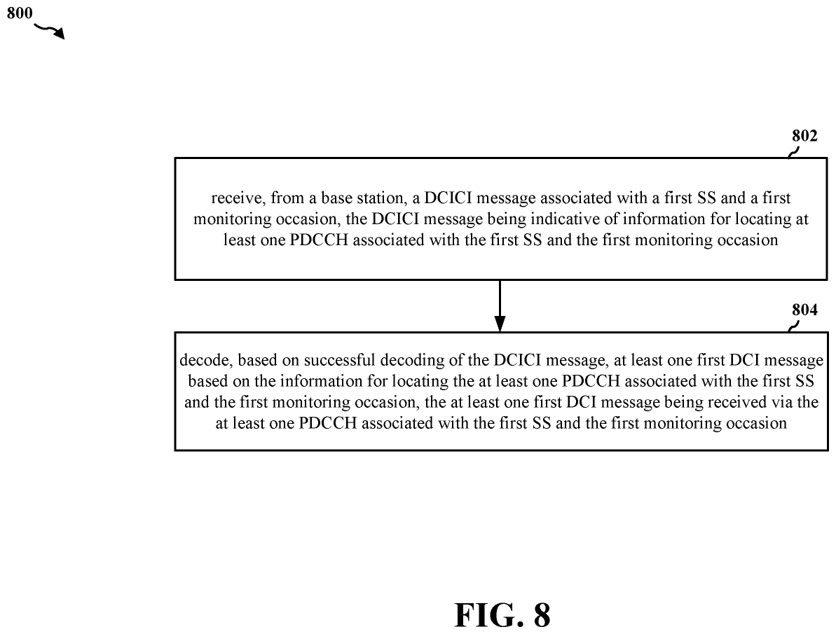

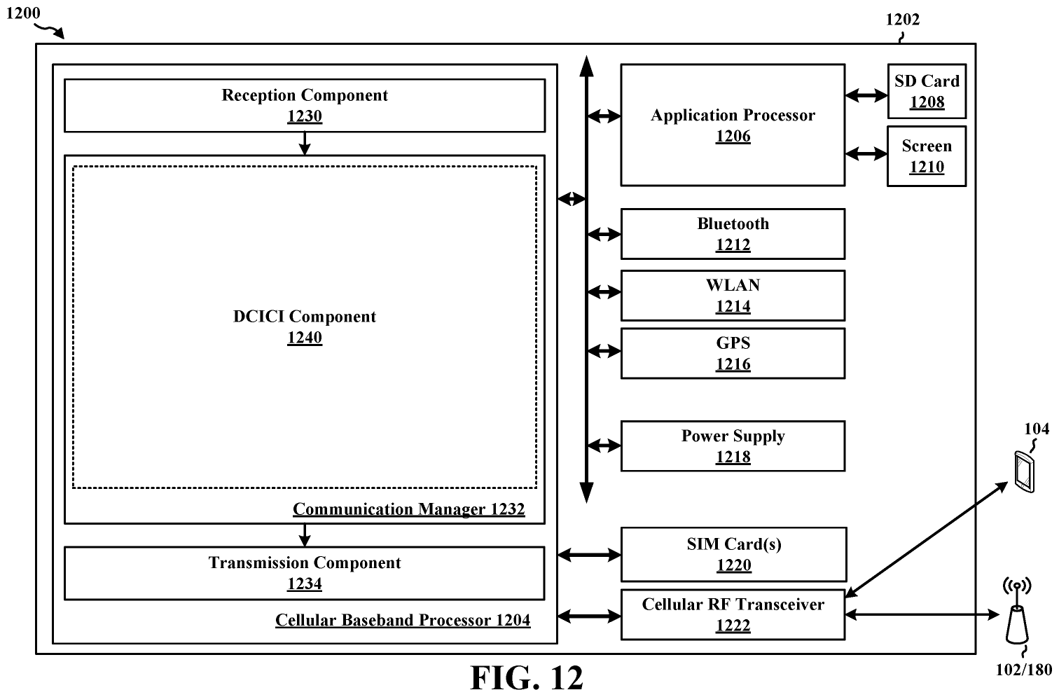

FIG. 8 is a flowchart 800 of a method of wireless communication. The method may be performed by a first UE (e.g., the UE 104/350; the first UE 702; the apparatus 1202). At 802, the first UE may receive, from a base station, a DCICI message associated with a first SS and a first monitoring occasion. The DCICI message may be indicative of information for locating at least one PDCCH associated with the first SS and the first monitoring occasion. For example, 802 may be performed by the DCICI component 1240 in FIG. 12. Referring to FIG. 7, at 710, the first UE 702 may receive, from a base station 704, a DCICI message associated with a first SS and a first monitoring occasion.

At 804, the first UE may decode, based on decoding of (e.g., successful decoding of) the DCICI message, at least one first DCI message based on the information for locating the at least one PDCCH associated with the first SS and the first monitoring occasion. The at least one first DCI message may be received via the at least one PDCCH associated with the first SS and the first monitoring occasion. For example, 804 may be performed by the DCICI component 1240 in FIG. 12. Referring to FIG. 7, at 714, the first UE 702 may decode, based on successful decoding of (e.g., successful decoding of) the DCICI message 710, at least one first DCI message 712 based on the information for locating the at least one PDCCH associated with the first SS and the first monitoring occasion.

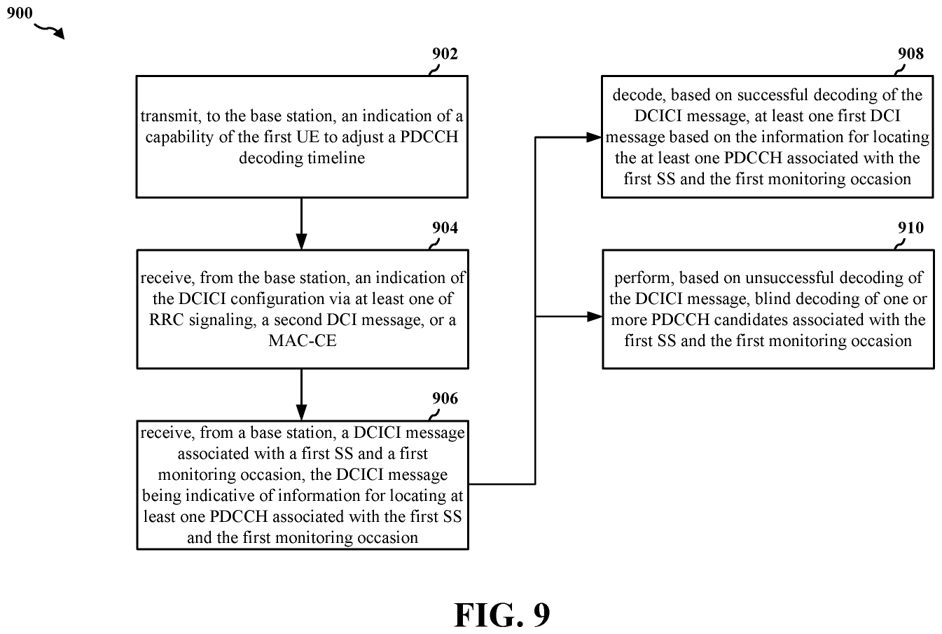

FIG. 9 is a flowchart 900 of a method of wireless communication. The method may be performed by a first UE (e.g., the UE 104/350; the first UE 702; the apparatus 1202). At 906, the first UE may receive, from a base station, a DCICI message associated with a first SS and a first monitoring occasion. The DCICI message may be indicative of information for locating at least one PDCCH associated with the first SS and the first monitoring occasion. For example, 906 may be performed by the DCICI component 1240 in FIG. 12. Referring to FIG. 7, at 710, the first UE 702 may receive, from a base station 704, a DCICI message associated with a first SS and a first monitoring occasion.

At 908, the first UE may decode, based on decoding of (e.g., successful decoding of) the DCICI message, at least one first DCI message based on the information for locating the at least one PDCCH associated with the first SS and the first monitoring occasion. The at least one first DCI message may be received via the at least one PDCCH associated with the first SS and the first monitoring occasion. For example, 908 may be performed by the DCICI component 1240 in FIG. 12. Referring to FIG. 7, at 714, the first UE 702 may decode, based on decoding of (e.g., successful decoding of) the DCICI message 710, at least one first DCI message 712 based on the information for locating the at least one PDCCH associated with the first SS and the first monitoring occasion.

In one configuration, the information for locating the at least one PDCCH associated with the first SS and the first monitoring occasion may include, for each PDCCH in the at least one PDCCH, an AL associated with the PDCCH and at least one of a PDCCH candidate ID associated with the PDCCH or a CCE index associated with the PDCCH.

In one configuration, referring to FIG. 7, the DCICI message 710 may further include an indication of a size of the at least one first DCI message 712.

In one configuration, referring to FIG. 7, the DCICI message 710 may further include an indication of a CC associated with the at least one PDCCH.

In one configuration, referring to FIG. 7, the DCICI message 710 may further include information relating to at least one third DCI message associated with the first SS and the first monitoring occasion. The at least one third DCI message may be for a second UE.

In one configuration, referring to FIG. 7, the DCICI message 710 may be associated with a special RNTI. The special RNTI may be different from an RNTI associated with the at least one first DCI message 712.

In one configuration, referring to FIG. 7, the DCICI message 710 may be associated with a DCICI configuration including an AL associated with a DCICI PDCCH and at least one of a PDCCH candidate ID associated with the DCICI PDCCH or a CCE index associated with the DCICI PDCCH. The DCICI message may be decoded based on the DCICI configuration. At 904, the first UE may receive, from the base station, an indication of the DCICI configuration via at least one of RRC signaling, a second DCI message, or a MAC-CE. For example, 904 may be performed by the DCICI component 1240 in FIG. 12. Referring to FIG. 7, at 708, the first UE 702 may receive, from the base station 704, an indication of the DCICI configuration 708 via at least one of RRC signaling, a second DCI message, or a MAC-CE.

In one configuration, the at least one PDCCH and the DCICI PDCCH may be associated with different CCE indexes.

In one configuration, at 910, the first UE may perform, based on decoding of (e.g., unsuccessful decoding of, such as failure to decode) the DCICI message, blind decoding of one or more PDCCH candidates associated with the first SS and the first monitoring occasion. For example, 910 may be performed by the DCICI component 1240 in FIG. 12. Referring to FIG. 7, at 716, the first UE 702 may perform, based on decoding of (e.g., unsuccessful decoding of, such as failure to decode) the DCICI message 710, blind decoding of one or more PDCCH candidates associated with the first.

In one configuration, at 902, the first UE may transmit, to the base station, an indication of a capability of the first UE to adjust a PDCCH decoding timeline. For example, 902 may be performed by the DCICI component 1240 in FIG. 12. Referring to FIG. 7, at 706, the first UE 702 may transmit, to the base station 704, an indication of a capability of the first UE 702 to adjust a PDCCH decoding timeline.

In one configuration, the first monitoring occasion may correspond to a first PDCCH monitoring occasion.

In one configuration, referring to FIG. 7, the DCICI message 710 may be received via the first SS at the first monitoring occasion.

In one configuration, referring to FIG. 7, the DCICI message 710 may be received at a second monitoring occasion prior to the first monitoring occasion, and may be received via the first SS or an SS different from the first SS.

In one configuration, a number (e.g., quantity) of one or more PDCCH candidates associated with the first SS may be greater than a threshold.

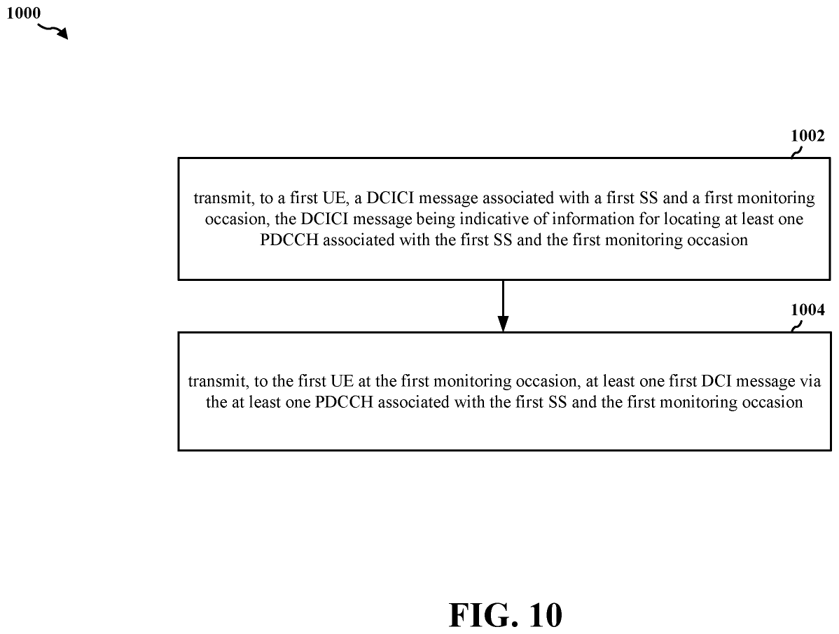

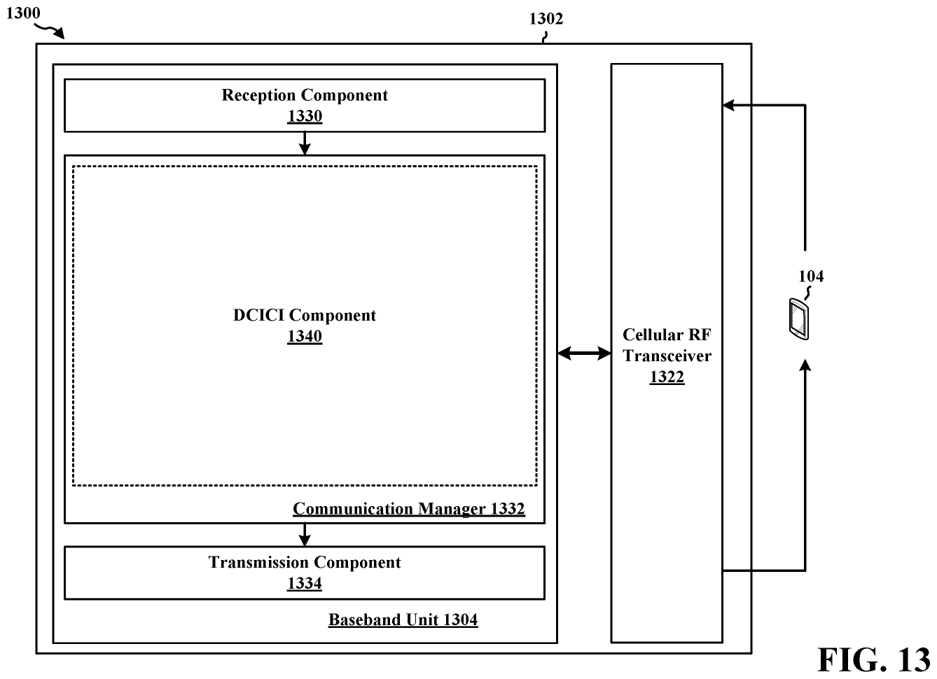

FIG. 10 is a flowchart 1000 of a method of wireless communication. The method may be performed by a base station (e.g., the base station 102/310/704; the apparatus 1302). At 1002, the base station may transmit, to a first UE, a DCICI message associated with a first SS and a first monitoring occasion. The DCICI message may be indicative of information for locating at least one PDCCH associated with the first SS and the first monitoring occasion. For example, 1002 may be performed by the DCICI component 1340 in FIG. 13. Referring to FIG. 7, at 710, the base station 704 may transmit, to a first UE 702, a DCICI message associated with a first SS and a first monitoring occasion.

At 1004, the base station may transmit, to the first UE at the first monitoring occasion, at least one first DCI message via the at least one PDCCH associated with the first SS and the first monitoring occasion. For example, 1004 may be performed by the DCICI component 1340 in FIG. 13. Referring to FIG. 7, at 712, the base station 704 may transmit, to the first UE 702 at the first monitoring occasion, at least one first DCI message via the at least one PDCCH associated with the first SS and the first monitoring occasion.

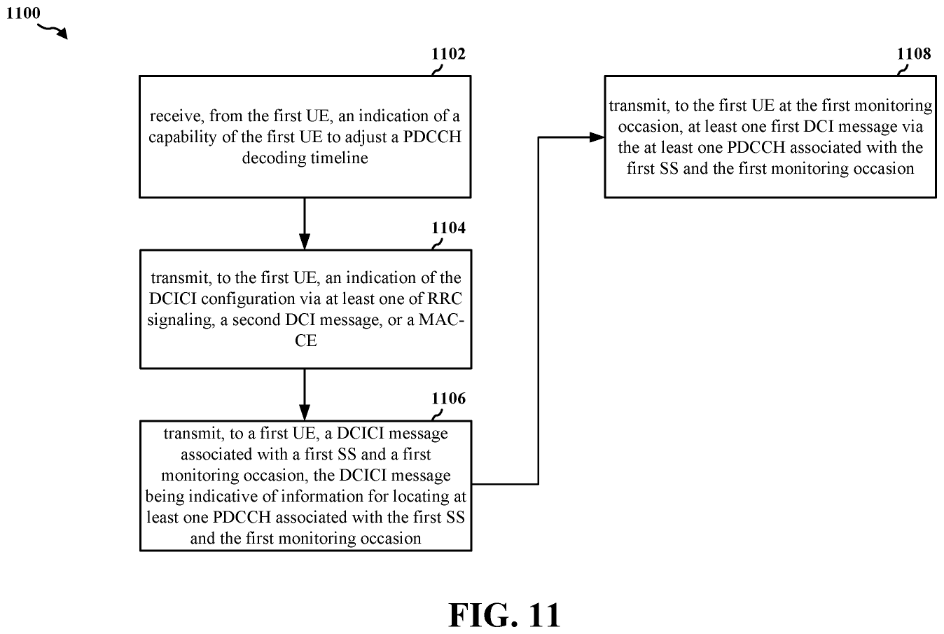

FIG. 11 is a flowchart 1100 of a method of wireless communication. The method may be performed by a base station (e.g., the base station 102/310/704; the apparatus 1302). At 1106, the base station may transmit, to a first UE, a DCICI message associated with a first SS and a first monitoring occasion. The DCICI message may be indicative of information for locating at least one PDCCH associated with the first SS and the first monitoring occasion. For example, 1106 may be performed by the DCICI component 1340 in FIG. 13. Referring to FIG. 7, at 710, the base station 704 may transmit, to a first UE 702, a DCICI message associated with a first SS and a first monitoring occasion.

At 1108, the base station may transmit, to the first UE at the first monitoring occasion, at least one first DCI message via the at least one PDCCH associated with the first SS and the first monitoring occasion. For example, 1108 may be performed by the DCICI component 1340 in FIG. 13. Referring to FIG. 7, at 712, the base station 704 may transmit, to the first UE 702 at the first monitoring occasion, at least one first DCI message via the at least one PDCCH associated with the first SS and the first monitoring occasion.

In one configuration, the information for locating the at least one PDCCH associated with the first SS and the first monitoring occasion may include, for each PDCCH in the at least one PDCCH, an AL associated with the PDCCH and at least one of a PDCCH candidate ID associated with the PDCCH or a CCE index associated with the PDCCH.

In one configuration, referring to FIG. 7, the DCICI message 710 may further include an indication of a size of the at least one first DCI message 712.

In one configuration, referring to FIG. 7, the DCICI message 710 may further include an indication of a CC associated with the at least one PDCCH.

In one configuration, referring to FIG. 7, the DCICI message 710 may further include information relating to at least one third DCI message associated with the first SS and the first monitoring occasion. The at least one third DCI message may be for a second UE.

In one configuration, referring to FIG. 7, the DCICI message 710 may be associated with a special RNTI. The special RNTI may be different from an RNTI associated with the at least one first DCI message.

In one configuration, referring to FIG. 7, the DCICI message 710 may be associated with a DCICI configuration including an AL associated with a DCICI PDCCH and at least one of a PDCCH candidate ID associated with the DCICI PDCCH or a CCE index associated with the DCICI PDCCH. At 1104, the base station may transmit, to the first UE, an indication of the DCICI configuration via at least one of RRC signaling, a second DCI message, or a MAC-CE. For example, 1104 may be performed by the DCICI component 1340 in FIG. 13. Referring to FIG. 7, at 708, the base station 704 may transmit, to the first UE 702, an indication of the DCICI configuration via at least one of RRC signaling, a second DCI message, or a MAC-CE.

In one configuration, the at least one PDCCH and the DCICI PDCCH may be associated with different CCE indexes.

In one configuration, the first monitoring occasion may correspond to a first PDCCH monitoring occasion.

In one configuration, referring to FIG. 7, the DCICI message 710 may be transmitted to the first UE 702 via the first SS at the first monitoring occasion based on a determination that the first SS at the first monitoring occasion is able to accommodate the DCICI message 710 and the at least one first DCI message 712.

In one configuration, at 1102, the base station may receive, from the first UE, an indication of a capability of the first UE to adjust a PDCCH decoding timeline. For example, 1102 may be performed by the DCICI component 1340 in FIG. 13. Referring to FIG. 7, at 706, the base station 704 may receive, from the first UE 702, an indication of a capability of the first UE 702 to adjust a PDCCH decoding timeline.

In one configuration, referring to FIG. 7, the DCICI message 710 may be transmitted to the first UE 702 via the first SS at the first monitoring occasion based on an indication received from the first UE 702 that the first UE 702 is capable of adjusting the PDCCH decoding timeline.

In one configuration, referring to FIG. 7, the DCICI message 710 may be transmitted to the first UE 702 at a second monitoring occasion prior to the first monitoring occasion based on an indication received from the first UE 702 that the first UE 702 is not capable of adjusting the PDCCH decoding timeline. The DCICI message 710 may be transmitted to the first UE 702 via the first SS or an SS different from the first SS.

In one configuration, referring to FIG. 7, the DCICI message 710 may be transmitted to the first UE 702 based on a determination that a number (e.g., quantity) of one or more PDCCH candidates associated with the first SS and the first monitoring occasion is greater than a threshold.

FIG. 12 is a diagram 1200 illustrating an example of a hardware implementation for an apparatus 1202. The apparatus 1202 may be a UE, a component of a UE, or may implement UE functionality. In some aspects, the apparatus 1202 may include a cellular baseband processor 1204 (also referred to as a modem) coupled to a cellular RF transceiver 1222. In some aspects, the apparatus 1202 may further include one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, or a power supply 1218. The cellular baseband processor 1204 communicates through the cellular RF transceiver 1222 with the UE 104 and/or BS 102. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the additional modules of the apparatus 1202.

The communication manager 1232 includes a DCICI component 1240 that may be configured to transmit, to the base station, an indication of a capability of the first UE to adjust a PDCCH decoding timeline, e.g., as described in connection with 902 in FIG. 9. The DCICI component 1240 may be configured to receive, from the base station, an indication of the DCICI configuration via at least one of RRC signaling, a second DCI message, or a MAC-CE, e.g., as described in connection with 904 in FIG. 9. The DCICI component 1240 may be configured to receive, from a base station, a DCICI message associated with a first SS and a first monitoring occasion, e.g., as described in connection with 802 in FIGS. 8 and 906 in FIG. 9. The DCICI component 1240 may be configured to decode, based on decoding of (e.g., successful decoding of) the DCICI message, at least one first DCI message based on the information for locating the at least one PDCCH associated with the first SS and the first monitoring occasion, e.g., as described in connection with 804 in FIGS. 8 and 908 in FIG. 9. The DCICI component 1240 may be configured to perform, based on decoding of (e.g., unsuccessful decoding of, such as failure to decode) the DCICI message, blind decoding of one or more PDCCH candidates associated with the first SS and the first monitoring occasion, e.g., as described in connection with 910 in FIG. 9.

The apparatus may include additional components that perform each of the blocks of the algorithm in the flowcharts of FIGS. 7-9. As such, each block in the flowcharts of FIGS. 7-9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the cellular baseband processor 1204, includes means for receiving, from a base station, a DCICI message associated with a first SS and a first monitoring occasion. The DCICI message may be indicative of information for locating at least one PDCCH associated with the first SS and the first monitoring occasion. The apparatus 1202, and in particular the cellular baseband processor 1204, includes means for decoding, based on decoding of (e.g., successful decoding of) the DCICI message, at least one first DCI message based on the information for locating the at least one PDCCH associated with the first SS and the first monitoring occasion. The at least one first DCI message may be received via the at least one PDCCH associated with the first SS and the first monitoring occasion.

In one configuration, the information for locating the at least one PDCCH associated with the first SS and the first monitoring occasion may include, for each PDCCH in the at least one PDCCH, an AL associated with the PDCCH and at least one of a PDCCH candidate ID associated with the PDCCH or a CCE index associated with the PDCCH. In one configuration, the DCICI message may further include an indication of a size of the at least one first DCI message. In one configuration, the DCICI message may further include an indication of a CC associated with the at least one PDCCH. In one configuration, the DCICI message may further include information relating to at least one third DCI message associated with the first SS and the first monitoring occasion. The at least one third DCI message may be for a second UE. In one configuration, the DCICI message may be associated with a special RNTI. The special RNTI may be different from an RNTI associated with the at least one first DCI message. In one configuration, the DCICI message may be associated with a DCICI configuration including an AL associated with a DCICI PDCCH and at least one of a PDCCH candidate ID associated with the DCICI PDCCH or a CCE index associated with the DCICI PDCCH. The DCICI message may be decoded based on the DCICI configuration. The apparatus 1202, and in particular the cellular baseband processor 1204, includes means for receiving, from the base station, an indication of the DCICI configuration via at least one of RRC signaling, a second DCI message, or a MAC-CE. In one configuration, the at least one PDCCH and the DCICI PDCCH may be associated with different CCE indexes. In one configuration, the apparatus 1202, and in particular the cellular baseband processor 1204, includes means for performing, based on decoding of (e.g., unsuccessful decoding of, such as failure to decode) the DCICI message, blind decoding of one or more PDCCH candidates associated with the first SS and the first monitoring occasion. In one configuration, the apparatus 1202, and in particular the cellular baseband processor 1204, includes means for transmitting, to the base station, an indication of a capability of the first UE to adjust a PDCCH decoding timeline. In one configuration, the first monitoring occasion may correspond to a first PDCCH monitoring occasion. In one configuration, the DCICI message may be received at a second monitoring occasion prior to the first monitoring occasion, and may be received via the first SS or an SS different from the first SS. In one configuration, a number (e.g., quantity) of one or more PDCCH candidates associated with the first SS may be greater than a threshold.

The means may be one or more of the components of the apparatus 1202 configured to perform the functions recited by the means. As described supra, the apparatus 1202 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 13 is a diagram 1300 illustrating an example of a hardware implementation for an apparatus 1302. The apparatus 1302 may be a base station, a component of a base station, or may implement base station functionality. In some aspects, the apparatus 1302 may include a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station 310 and may include the memory 376 and/or at least one of the TX processor 316, the RX processor 370, and the controller/processor 375.

The communication manager 1332 includes a DCICI component 1340 that may be configured to receive, from the first UE, an indication of a capability of the first UE to adjust a PDCCH decoding timeline, e.g., as described in connection with 1102 in FIG. 11. The DCICI component 1340 may be configured to transmit, to the first UE, an indication of the DCICI configuration via at least one of RRC signaling, a second DCI message, or a MAC-CE, e.g., as described in connection with 1104 in FIG. 11. The DCICI component 1340 may be configured to transmit, to a first UE, a DCICI message associated with a first SS and a first monitoring occasion, e.g., as described in connection with 1002 in FIGS. 10 and 1106 in FIG. 11. The DCICI component 1340 may be configured to transmit, to the first UE at the first monitoring occasion, at least one first DCI message via the at least one PDCCH associated with the first SS and the first monitoring occasion, e.g., as described in connection with 1004 in FIGS. 10 and 1108 in FIG. 11.

The apparatus may include additional components that perform each of the blocks of the algorithm in the flowcharts of FIGS. 7, 10, and 11. As such, each block in the flowcharts of FIGS. 7, 10, and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the baseband unit 1304, includes means for transmitting, to a first UE, a DCICI message associated with a first SS and a first monitoring occasion. The DCICI message may be indicative of information for locating at least one PDCCH associated with the first SS and the first monitoring occasion. The apparatus 1302, and in particular the baseband unit 1304, includes means for transmitting, to the first UE at the first monitoring occasion, at least one first DCI message via the at least one PDCCH associated with the first SS and the first monitoring occasion.

In one configuration, the information for locating the at least one PDCCH associated with the first SS and the first monitoring occasion may include, for each PDCCH in the at least one PDCCH, an AL associated with the PDCCH and at least one of a PDCCH candidate ID associated with the PDCCH or a CCE index associated with the PDCCH. In one configuration, the DCICI message may further include an indication of a size of the at least one first DCI message. In one configuration, the DCICI message may further include an indication of a CC associated with the at least one PDCCH. In one configuration, the DCICI message may further include information relating to at least one third DCI message associated with the first SS and the first monitoring occasion. The at least one third DCI message may be for a second UE. In one configuration, the DCICI message may be associated with a special RNTI. The special RNTI may be different from an RNTI associated with the at least one first DCI message. In one configuration, the DCICI message may be associated with a DCICI configuration including an AL associated with a DCICI PDCCH and at least one of a PDCCH candidate ID associated with the DCICI PDCCH or a CCE index associated with the DCICI PDCCH. The apparatus 1302, and in particular the baseband unit 1304, includes means for transmitting, to the first UE, an indication of the DCICI configuration via at least one of RRC signaling, a second DCI message, or a MAC-CE. In one configuration, the at least one PDCCH and the DCICI PDCCH may be associated with different CCE indexes. In one configuration, the first monitoring occasion may correspond to a first PDCCH monitoring occasion. In one configuration, the DCICI message may be transmitted to the first UE via the first SS at the first monitoring occasion based on a determination that the first SS at the first monitoring occasion is able to accommodate the DCICI message and the at least one first DCI message. In one configuration, the apparatus 1302, and in particular the baseband unit 1304, includes means for receiving, from the first UE, an indication of a capability of the first UE to adjust a PDCCH decoding timeline. In one configuration, the DCICI message may be transmitted to the first UE via the first SS at the first monitoring occasion based on an indication received from the first UE that the first UE is capable of adjusting the PDCCH decoding timeline. In one configuration, the DCICI message may be transmitted to the first UE at a second monitoring occasion prior to the first monitoring occasion based on an indication received from the first UE that the first UE is not capable of adjusting the PDCCH decoding timeline. The DCICI message may be transmitted to the first UE via the first SS or an SS different from the first SS. In one configuration, the DCICI message may be transmitted to the first UE based on a determination that a number (quantity) of one or more PDCCH candidates associated with the first SS and the first monitoring occasion is greater than a threshold.

The means may be one or more of the components of the apparatus 1302 configured to perform the functions recited by the means. As described supra, the apparatus 1302 may include the TX Processor 316, the RX Processor 370, and the controller/processor 375. As such, in one configuration, the means may be the TX Processor 316, the RX Processor 370, and the controller/processor 375 configured to perform the functions recited by the means.

Referring back to FIGS. 4-13, a base station may transmit to a first UE, and the first UE may receive from the base station, a DCICI message associated with a first SS and a first monitoring occasion. The DCICI message may be indicative of information for locating at least one PDCCH associated with the first SS and the first monitoring occasion. The base station may transmit to the first UE at the first monitoring occasion at least one first DCI message via the at least one PDCCH associated with the first SS and the first monitoring occasion. The first UE may decode, based on decoding of (e.g., successful decoding of) the DCICI message, the at least one first DCI message based on the information for locating the at least one PDCCH associated with the first SS and the first monitoring occasion. Accordingly, based on the DCICI message, the UE may perform fewer decodes of PDCCH candidates. Power savings at the UE may be achieved.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an first network node for wireless communication including at least one processor coupled to a memory and configured to receive, from a second network node, a DCICI message associated with a first SS and a first monitoring occasion, where the DCICI message is indicative of information for locating at least one PDCCH associated with the first SS and the first monitoring occasion; and decode, based on successful decoding of the DCICI message, a first DCI message based on the information for locating the at least one PDCCH associated with the first SS and the first monitoring occasion, where the first DCI message corresponds to the at least one PDCCH associated with the first SS and the first monitoring occasion.

Aspect 2 is the first network node of aspect 1, where the information for locating the at least one PDCCH associated with the first SS and the first monitoring occasion includes, for each respective PDCCH of the at least one PDCCH, a respective AL associated with the respective PDCCH and at least one of a respective PDCCH candidate ID associated with the respective PDCCH or a respective CCE index associated with the respective PDCCH.

Aspect 3 is the first network node of any of aspects 1 and 2, where the DCICI message includes at least one of: an indication of a size of the first DCI message; or an indication of a CC associated with the at least one PDCCH.

Aspect 4 is the first network node of any of aspects 1 to 3, where the information for locating the at least one PDCCH associated with the first SS and the first monitoring occasion is the DCICI message, information included in the DCICI message, or a combination thereof.

Aspect 5 is the first network node of any of aspects 1 to 4, where the DCICI message includes information relating to a second DCI message associated with the first SS and the first monitoring occasion, and where the second DCI message is for a third network node, where the first network node is a first UE and the third network node is a second UE.

Aspect 6 is the first network node of any of aspects 1 to 5, where the DCICI message is associated with a special RNTI, and the special RNTI is different from an RNTI associated with the first DCI message.

Aspect 7 is the first network node of any of aspects 1 to 6, where the DCICI message is associated with a DCICI configuration including: an AL associated with a DCICI PDCCH, and at least one of a PDCCH candidate ID associated with the DCICI PDCCH or a CCE index associated with the DCICI PDCCH, where the at least one processor is configured to: receive, from the second network node, information indicative of the DCICI configuration via at least one of RRC signaling, a second DCI message, or a MAC-CE; and decode the DCICI message based on the DCICI configuration.

Aspect 8 is the first network node of aspect 7, where the at least one PDCCH and the DCICI PDCCH are associated with different CCE indexes.

Aspect 9 is the first network node of any of aspects 1 to 8, where the at least one processor is configured to: perform, based on unsuccessful decoding of the DCICI message, blind decoding of one or more PDCCH candidates associated with the first SS and the first monitoring occasion.

Aspect 10 is the first network node of any of aspects 1 to 9, where the at least one processor is configured to: transmit, to the second network node, an indication of a capability of the first network node to adjust a PDCCH decoding timeline.

Aspect 11 is the first network node of any of aspects 1 to 10, where the first monitoring occasion corresponds to a first PDCCH monitoring occasion.

Aspect 12 is the first network node of any of aspects 1 to 11, where, to receive the DCICI message, the at least one processor is configured to receive the DCICI message via the first SS at the first monitoring occasion.

Aspect 13 is the first network node of any of aspects 1 to 11, where, to receive the DCICI message, the at least one processor is configured to receive, via the first SS or an SS different from the first SS, the DCICI message at a second monitoring occasion prior to the first monitoring occasion.

Aspect 14 is the first network node of any of aspects 1 to 13, where a number of one or more PDCCH candidates associated with the first SS is greater than a threshold.

Aspect 15 is the first network node of any of aspects 1 to 14, further including a transceiver coupled to the at least one processor.

Aspect 16 is a first network node for wireless communication including at least one processor coupled to a memory and configured to transmit, to a second network node, a DCICI message associated with a first SS and a first monitoring occasion, where the DCICI message is indicative of information for locating at least one PDCCH associated with the first SS and the first monitoring occasion; and transmit, to the second network node at the first monitoring occasion, a first DCI message via the at least one PDCCH associated with the first SS and the first monitoring occasion.

Aspect 17 is the first network node of aspect 16, where the information for locating the at least one PDCCH associated with the first SS and the first monitoring occasion includes, for each respective PDCCH of the at least one PDCCH, a respective AL associated with the respective PDCCH and at least one of a respective PDCCH candidate ID associated with the respective PDCCH or a respective CCE index associated with the respective PDCCH.

Aspect 18 is the first network node of any of aspects 16 and 17, where the DCICI message includes at least one of: an indication of a size of the first DCI message; or an indication of a CC associated with the at least one PDCCH.

Aspect 19 is the first network node of any of aspects 16 to 18, where the information for locating the at least one PDCCH associated with the first SS and the first monitoring occasion is the DCICI message, information included in the DCICI message, or a combination thereof.

Aspect 20 is the first network node of any of aspects 16 to 19, where the DCICI message includes information relating to a second DCI message associated with the first SS and the first monitoring occasion, and the second DCI message is for a third network node, where the second network node is a first UE and the third network node is a second UE.

Aspect 21 is the first network node of any of aspects 16 to 20, where the DCICI message is associated with a special RNTI, and the special RNTI is different from an RNTI associated with the first DCI message.

Aspect 22 is the first network node of any of aspects 16 to 21, where the DCICI message is associated with a DCICI configuration including: an AL associated with a DCICI PDCCH, and at least one of a PDCCH candidate ID associated with the DCICI PDCCH or a CCE index associated with the DCICI PDCCH, and where the at least one processor is configured to transmit, to the second network node, an indication of the DCICI configuration via at least one of RRC signaling, a second DCI message, or a MAC-CE.

Aspect 23 is the first network node of aspect 22, where the at least one PDCCH and the DCICI PDCCH are associated with different CCE indexes.

Aspect 24 is the first network node of any of aspects 16 to 23, where the first monitoring occasion corresponds to a first PDCCH monitoring occasion.

Aspect 25 is the first network node of any of aspects 16 to 24, where the at least one processor is configured to: determine that the first SS at the first monitoring occasion is able to accommodate the DCICI message, where, to transmit the DCICI message, the at least one processor is configured to transmit, based on the determination, the DCICI message to the second network node via the first SS at the first monitoring occasion.

Aspect 26 is the first network node of any of aspects 16 to 25, where the at least one processor is configured to: receive, from second network node, an indication of a capability of the second network node to adjust a PDCCH decoding timeline.

Aspect 27 is the first network node of any of aspects 16 to 26, where, to transmit the DCICI message, the at least one processor is configured to transmit the DCICI message to the second network node via the first SS at the first monitoring occasion based on the indication of the capability of the second network node to adjust the PDCCH decoding timeline, where the indication indicates that the second network node is capable of adjusting the PDCCH decoding timeline.

Aspect 28 is the first network node of any of aspects 16 to 24 and 26, where, to transmit the DCICI message, the at least one processor is configured to transmit, via the first SS or an SS different from the first SS, the DCICI message to the second network node at a second monitoring occasion prior to the first monitoring occasion based on the indication of the capability of the second network node to adjust the PDCCH decoding timeline, where the indication indicates that the second network node is not capable of adjusting the PDCCH decoding timeline.

Aspect 29 is the first network node of any of aspects 16 to 28, where the at least one processor is configured to: determine that a number of one or more PDCCH candidates associated with the first SS and the first monitoring occasion is greater than a threshold, where, to transmit the DCICI message, the at least one processor is configured to transmit the DCICI message to the second network node based on the determination.

Aspect 30 is the first network node of any of aspects 16 to 29, further including a transceiver coupled to the at least one processor.

Aspect 31 is a method of wireless communication for implementing any of aspects 1 to 30.

Aspect 32 is an apparatus for wireless communication including means for implementing any of aspects 1 to 30.

Aspect 33 is a computer-readable medium storing computer executable code, where the code when executed by a processor causes the processor to implement any of aspects 1 to 30.

What is claimed is:

1. A first network node for wireless communication, comprising:
a memory; and
at least one processor coupled to the memory, wherein the at least one memory is configured to:
receive, from a second network node, a downlink control information (DCI) candidate indication (CI) (DCICI) message associated with a first search space (SS) and a first monitoring occasion, wherein the DCICI message is indicative of information for locating at least one physical downlink control channel (PDCCH) associated with the first SS and the first monitoring occasion; and
decode, based on successful decoding of the DCICI message, a first DCI message based on the information for locating the at least one PDCCH associated with the first SS and the first monitoring occasion, wherein the first DCI message corresponds to the at least one PDCCH associated with the first SS and the first monitoring occasion.

2. The first network node of claim 1, wherein the information for locating the at least one PDCCH associated with the first SS and the first monitoring occasion comprises, for each respective PDCCH of the at least one PDCCH, a respective aggregation level (AL) associated with the respective PDCCH and at least one of a respective PDCCH candidate identifier (ID) associated with the respective PDCCH or a respective control channel element (CCE) index associated with the respective PDCCH.

3. The first network node of claim 1, wherein the DCICI message comprises at least one of:
an indication of a size of the first DCI message; or
an indication of a component carrier (CC) associated with the at least one PDCCH.

4. The first network node of claim 1, wherein the information for locating the at least one PDCCH associated with the first SS and the first monitoring occasion is the DCICI message, information included in the DCICI message, or a combination thereof.

5. The first network node of claim 1, wherein the DCICI message includes information relating to a second DCI message associated with the first SS and the first monitoring occasion, and wherein the second DCI message is for a third network node, wherein the first network node is a first user equipment (UE) and the third network node is a second UE.

6. The first network node of claim 1, wherein the DCICI message is associated with a special radio network temporary identifier (RNTI), and the special RNTI is different from an RNTI associated with the first DCI message.

7. The first network node of claim 1, wherein the DCICI message is associated with a DCICI configuration comprising: an aggregation level (AL) associated with a PDCCH associated with the DCICI message (DCICI PDCCH), and at least one of a PDCCH candidate identifier (ID) associated with the DCICI PDCCH or a control channel element (CCE) index associated with the DCICI PDCCH, wherein the at least one processor is configured to:
receive, from the second network node, information indicative of the DCICI configuration via at least one of radio resource control (RRC) signaling, a second DCI message, or a medium access control (MAC)—control element (CE) (MAC-CE); and
decode the DCICI message based on the DCICI configuration.

8. The first network node of claim 7, wherein the at least one PDCCH and the DCICI PDCCH are associated with different CCE indexes.

9. The first network node of claim 1, wherein the at least one processor is configured to:
perform, based on unsuccessful decoding of the DCICI message, blind decoding of one or more PDCCH candidates associated with the first SS and the first monitoring occasion.

10. The first network node of claim 1, wherein the at least one processor is configured to:
transmit, to the second network node, an indication of a capability of the first network node to adjust a PDCCH decoding timeline.

11. The first network node of claim 1, wherein the first monitoring occasion corresponds to a first PDCCH monitoring occasion.

12. The first network node of claim 1, wherein, to receive the DCICI message, the at least one processor is configured to receive the DCICI message via the first SS at the first monitoring occasion.

13. The first network node of claim 1, wherein, to receive the DCICI message, the at least one processor is configured to receive, via the first SS or an SS different from the first SS, the DCICI message at a second monitoring occasion prior to the first monitoring occasion.

14. The first network node of claim 1, wherein a number of one or more PDCCH candidates associated with the first SS is greater than a threshold.

15. A method of wireless communication performed by a first network node, comprising:
receiving, from a second network node, a downlink control information (DCI) candidate indication (CI) (DCICI) message associated with a first search space (SS) and a first monitoring occasion, wherein the DCICI message is indicative of information for locating at least one physical downlink control channel (PDCCH) associated with the first SS and the first monitoring occasion; and
decoding, based on successful decoding of the DCICI message, a first DCI message based on the information for locating the at least one PDCCH associated with the first SS and the first monitoring occasion, wherein the first DCI message is received via the at least one PDCCH associated with the first SS and the first monitoring occasion.

16. A first network node for wireless communication, comprising:
a memory; and
at least one processor coupled to the memory, wherein the at least one processor is configured to:
transmit, to a second network node, a downlink control information (DCI) candidate indication (CI) (DCICI) message associated with a first search space (SS) and a first monitoring occasion, wherein the DCICI message is indicative of information for locating at least one physical downlink control channel (PDCCH) associated with the first SS and the first monitoring occasion; and
transmit, to the second network node at the first monitoring occasion, a first DCI message via the at least one PDCCH associated with the first SS and the first monitoring occasion.

17. The first network node of claim 16, wherein the information for locating the at least one PDCCH associated with the first SS and the first monitoring occasion comprises, for each respective PDCCH of the at least one PDCCH, a respective aggregation level (AL) associated with the respective PDCCH and at least one of a respective PDCCH candidate identifier (ID) associated with the respective PDCCH or a respective control channel element (CCE) index associated with the respective PDCCH.

18. The first network node of claim 16, wherein the DCICI message comprises at least one of:
an indication of a size of the first DCI message; or
an indication of a component carrier (CC) associated with the at least one PDCCH.

19. The first network node of claim 16, wherein the information for locating the at least one PDCCH associated with the first SS and the first monitoring occasion is the DCICI message, information included in the DCICI message, or a combination thereof.

20. The first network node of claim 16, wherein the DCICI message includes information relating to a second DCI message associated with the first SS and the first monitoring occasion, and the second DCI message is for a third network node, wherein the second network node is a first user equipment (UE) and the third network node is a second UE.

21. The first network node of claim 16, wherein the DCICI message is associated with a special radio network temporary identifier (RNTI), and the special RNTI is different from an RNTI associated with the first DCI message.

22. The first network node of claim 16, wherein the DCICI message is associated with a DCICI configuration comprising: an aggregation level (AL) associated with a PDCCH associated with the DCICI message (DCICI PDCCH), and at least one of a PDCCH candidate ID associated with the DCICI PDCCH or a control channel element (CCE) index associated with the DCICI PDCCH, and wherein the at least one processor is configured to transmit, to the second network node, an indication of the DCICI configuration via at least one of radio resource control (RRC) signaling, a second DCI message, or a medium access control (MAC)—control element (CE) (MAC-CE).

23. The first network node of claim 22, wherein the at least one PDCCH and the DCICI PDCCH are associated with different CCE indexes.

24. The first network node of claim 16, wherein the first monitoring occasion corresponds to a first PDCCH monitoring occasion.

25. The first network node of claim 16, wherein the at least one processor is configured to:
determine that the first SS at the first monitoring occasion is able to accommodate the DCICI message, wherein, to transmit the DCICI message, the at least one processor is configured to transmit, based on the determination, the DCICI message to the second network node via the first SS at the first monitoring occasion.

26. The first network node of claim 16, wherein the at least one processor is configured to:
receive, from second network node, an indication of a capability of the second network node to adjust a PDCCH decoding timeline.

27. The first network node of claim 26, wherein, to transmit the DCICI message, the at least one processor is configured to transmit the DCICI message to the second network node via the first SS at the first monitoring occasion based on the indication of the capability of the second network node to adjust the PDCCH decoding timeline, wherein the indication indicates that the second network node is capable of adjusting the PDCCH decoding timeline.

28. The first network node of claim 26, wherein, to transmit the DCICI message, the at least one processor is configured to transmit, via the first SS or an SS different from the first SS, the DCICI message to the second network node at a second monitoring occasion prior to the first monitoring occasion based on the indication of the capability of the second network node to adjust the PDCCH decoding timeline, wherein the indication indicates that the second network node is not capable of adjusting the PDCCH decoding timeline.

29. The first network node of claim 16, wherein the at least one processor is configured to:
determine that a number of one or more PDCCH candidates associated with the first SS and the first monitoring occasion is greater than a threshold, wherein, to transmit the DCICI message, the at least one processor is configured to transmit the DCICI message to the second network node based on the determination.

30. A method of wireless communication performed by a first network node, comprising:
transmitting, to a second network node, a downlink control information (DCI) candidate indication (CI) (DCICI) message associated with a first search space (SS) and a first monitoring occasion, wherein the DCICI message is indicative of information for locating at least one physical downlink control channel (PDCCH) associated with the first SS and the first monitoring occasion; and
transmitting, to the second network node at the first monitoring occasion, at least one DCI message via the at least one PDCCH associated with the first SS and the first monitoring occasion.
